(19) United States
(12) Patent Application Publication
(10) Pub. No.: US 2024/0241991 A1
(43) Pub. Date: Jul. 18, 2024

(54) SYSTEM AND METHOD FOR MODULE MANAGEMENT

(71) Applicant: RAKUTEN SYMPHONY SINGAPORE PTE. LTD., Singapore (SG)

(72) Inventors: Keshav SHARMA, Indore (IN); Pranav SOOCHIK, Indore (IN); Aditya BUDHOLIYA, Indore (IN); Yatendra SINGH, Indore (IN)

(73) Assignee: RAKUTEN SYMPHONY SINGAPORE PTE. LTD., Singapore (SG)

(21) Appl. No.: 17/909,775

(22) PCT Filed: Jul. 7, 2022
(86) PCT No.: PCT/US2022/036287

§ 371 Date: Sep. 7, 2022

(51) Int. Cl. G06F 21/62

(52) U.S. Cl. CPC G06F 21/629

(57) ABSTRACT

A method of a module management system includes configuring a module corresponding to a parent application, generating at least one permission corresponding to the module, generating a first role based on the at least one permission, and assigning the first role to a user such that the user is granted the at least one permission and is able to utilize the parent application.

### BACKGROUND

### 1. Field

Apparatuses and methods consistent with example embodiments of the present disclosure relate to module management in a permissions-based system architecture.

### 2. Description of Related Art

In a system for managing applications, permissions, and user access to various applications, permissions and roles may be set to users. However, there is no mechanism for mapping a role directly to an application or module. Further, existing systems do not allow for the dynamic creation or updating of a configuration for an application or module to control user access without requiring redeployment of the system for managing the application. Such redeployment is time consuming, costly, and inconvenient, thereby making it difficult to change or update a configuration.

### SUMMARY

According to embodiments, systems and methods are provided for module management is a system that manages accesses of users.

According to an aspect of the disclosure, a method of a module management system may include configuring a module corresponding to a parent application, generating at least one permission corresponding to the module, generating a first role based on the at least one permission, and assigning the first role to a user such that the user is granted the at least one permission and is able to utilize the parent application.

According to an aspect of the disclosure, a module management system may include a memory storing instructions, and a processor configured to execute the instructions to configure a module corresponding to a parent application, generate at least one permission corresponding to the module, generate a first role based on the at least one permission, and assign the first role to a user such that the user is granted the at least one permission and is able to utilize the parent application.

According to an aspect of the disclosure, a non-transitory computer-readable storage medium of a module management system may store instructions that, when executed by at least one processor, cause the at least one processor to configure a module corresponding to a parent application, generate at least one permission corresponding to the module, generate a first role based on the at least one permission, and assign the first role to a user such that the user is granted the at least one permission and is able to utilize the parent application.

Additional aspects will be set forth in part in the description that follows and, in part, will be apparent from the description, or may be realized by practice of the presented embodiments of the disclosure.

### BRIEF DESCRIPTION OF THE DRAWINGS

Features, advantages, and significance of exemplary embodiments of the disclosure will be described below with reference to the accompanying drawings, in which like signs denote like elements, and wherein:

FIG. 1 is a diagram of an example environment in which systems and/or methods, described herein, may be implemented;

FIG. 2 is a diagram of example components of a device according to an embodiment;

FIG. 3 is a diagram of a module management system, according to an embodiment;

FIG. 4 is a diagram of an example permission assignment, according to an embodiment;

FIGS. 5A, 5B, 5C, 5D, 5E, 5F, 5G, and 5H are diagrams showing a configuration of a module, according to an embodiment;

FIGS. 6A, 6B and 6C are diagrams showing dynamic application of permissions, according to an embodiment;

FIGS. 7A, 7B, 7C, 7D, 7E and 7F are diagrams showing role assignment, according to an embodiment;

FIGS. 8A and 8B are diagrams showing displays of parent applications and child applications, according to an embodiment; and

FIG. 9 is a flowchart of a method of a module management system, according to an embodiment.

### DETAILED DESCRIPTION

The following detailed description of example embodiments refers to the accompanying drawings. The same reference numbers in different drawings may identify the same or similar elements.

The foregoing disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code. It is understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

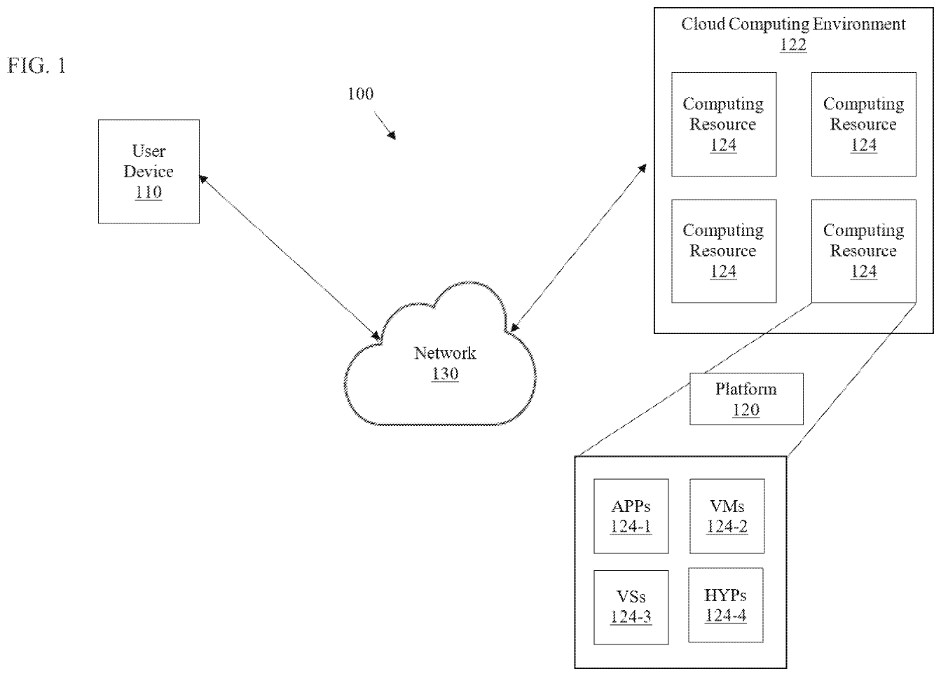

FIG. 1 is a diagram of an example environment 100 in which systems and/or methods, described herein, may be implemented. As shown in FIG. 1, environment 100 may include a user device 110, a platform 120, and a network 130. Devices of environment 100 may interconnect via wired connections, wireless connections, or a combination of wired and wireless connections. In embodiments, any of the functions and operations described with reference to FIG. 1 above may be performed by any combination of elements illustrated in FIG. 1.

User device 110 includes one or more devices capable of receiving, generating, storing, processing, and/or providing information associated with platform 120. For example, user device 110 may include a computing device (e.g., a desktop computer, a laptop computer, a tablet computer, a handheld computer, a smart speaker, a server, etc.), a mobile phone (e.g., a smart phone, a radiotelephone, etc.), a wearable device (e.g., a pair of smart glasses or a smart watch), or a similar device. In some implementations, user device 110 may receive information from and/or transmit information to platform 120.

Platform 120 includes one or more devices capable of receiving, generating, storing, processing, and/or providing information. In some implementations, platform 120 may include a cloud server or a group of cloud servers. In some implementations, platform 120 may be designed to be modular such that certain software components may be swapped in or out depending on a particular need. As such, platform 120 may be easily and/or quickly reconfigured for different uses.

In some implementations, as shown, platform 120 may be hosted in cloud computing environment 122. Notably, while implementations described herein describe platform 120 as being hosted in cloud computing environment 122, in some implementations, platform 120 may not be cloud-based (i.e., may be implemented outside of a cloud computing environment) or may be partially cloud-based.

Cloud computing environment 122 includes an environment that hosts platform 120. Cloud computing environment 122 may provide computation, software, data access, storage, etc. services that do not require end-user (e.g., user device 110) knowledge of a physical location and configuration of system(s) and/or device(s) that hosts platform 120. As shown, cloud computing environment 122 may include a group of computing resources 124 (referred to collectively as “computing resources 124” and individually as “computing resource 124”).

Computing resource 124 includes one or more personal computers, a cluster of computing devices, workstation computers, server devices, or other types of computation and/or communication devices. In some implementations, computing resource 124 may host platform 120. The cloud resources may include compute instances executing in computing resource 124, storage devices provided in computing resource 124, data transfer devices provided by computing resource 124, etc. In some implementations, computing resource 124 may communicate with other computing resources 124 via wired connections, wireless connections, or a combination of wired and wireless connections.

As further shown in FIG. 1, computing resource 124 includes a group of cloud resources, such as one or more applications (“APPs”) 124-1, one or more virtual machines (“VMs”) 124-2, virtualized storage (“VSs”) 124-3, one or more hypervisors (“HYPs”) 124-4, or the like.

Application 124-1 includes one or more software applications that may be provided to or accessed by user device 110. Application 124-1 may eliminate a need to install and execute the software applications on user device 110. For example, application 124-1 may include software associated with platform 120 and/or any other software capable of being provided via cloud computing environment 122. In some implementations, one application 124-1 may send/receive information to/from one or more other applications 124-1, via virtual machine 124-2.

Virtual machine 124-2 includes a software implementation of a machine (e.g., a computer) that executes programs like a physical machine. Virtual machine 124-2 may be either a system virtual machine or a process virtual machine, depending upon use and degree of correspondence to any real machine by virtual machine 124-2. A system virtual machine may provide a complete system platform that supports execution of a complete operating system (“OS”). A process virtual machine may execute a single program, and may support a single process. In some implementations, virtual machine 124-2 may execute on behalf of a user (e.g., user device 110), and may manage infrastructure of cloud computing environment 122, such as data management, synchronization, or long-duration data transfers.

Virtualized storage 124-3 includes one or more storage systems and/or one or more devices that use virtualization techniques within the storage systems or devices of computing resource 124. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

Hypervisor 124-4 may provide hardware virtualization techniques that allow multiple operating systems (e.g., “guest operating systems”) to execute concurrently on a host computer, such as computing resource 124. Hypervisor 124-4 may present a virtual operating platform to the guest operating systems, and may manage the execution of the guest operating systems. Multiple instances of a variety of operating systems may share virtualized hardware resources.

Network 130 includes one or more wired and/or wireless networks. For example, network 130 may include a cellular network (e.g., a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, or the like, and/or a combination of these or other types of networks.

The number and arrangement of devices and networks shown in FIG. 1 are provided as an example. In practice, there may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) of environment 100 may perform one or more functions described as being performed by another set of devices of environment 100.

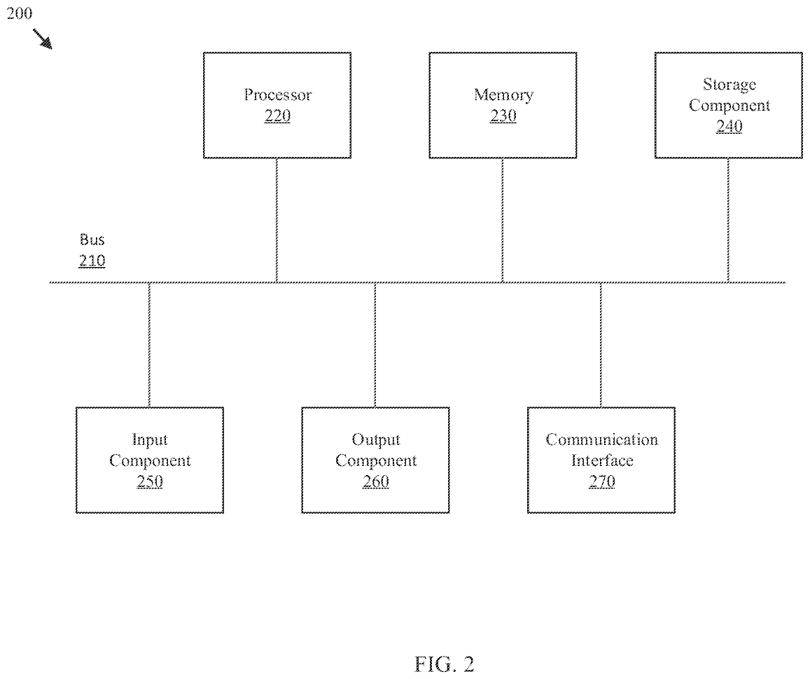

FIG. 2 is a diagram of example components of a device 200. Device 200 may correspond to user device 110 and/or platform 120. As shown in FIG. 2, device 200 may include a bus 210, a processor 220, a memory 230, a storage component 240, an input component 250, an output component 260, and a communication interface 270.

Bus 210 includes a component that permits communication among the components of device 200. Processor 220 may be implemented in hardware, firmware, or a combination of hardware and software. Processor 220 may be a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, processor 220 includes one or more processors capable of being programmed to perform a function. Memory 230 includes a random access memory (RAM), a read only memory (ROM), and/or another type of dynamic or static storage device (e.g., a flash memory, a magnetic memory, and/or an optical memory) that stores information and/or instructions for use by processor 220.

Storage component 240 stores information and/or software related to the operation and use of device 200. For example, storage component 240 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive. Input component 250 includes a component that permits device 200 to receive information, such as via user input (e.g., a touch screen display, a keyboard, a keypad, a mouse, a button, a switch, and/or a microphone). Additionally, or alternatively, input component 250 may include a sensor for sensing information (e.g., a global positioning system (GPS) component, an accelerometer, a gyroscope, and/or an actuator). Output component 260 includes a component that provides output information from device 200 (e.g., a display, a speaker, and/or one or more light-emitting diodes (LEDs)).

Communication interface 270 includes a transceiver-like component (e.g., a transceiver and/or a separate receiver and transmitter) that enables device 200 to communicate with other devices, such as via a wired connection, a wireless connection, or a combination of wired and wireless connections. Communication interface 270 may permit device 200 to receive information from another device and/or provide information to another device. For example, communication interface 270 may include an Ethernet interface, an optical interface, a coaxial interface, an infrared interface, a radio frequency (RF) interface, a universal serial bus (USB) interface, a Wi-Fi interface, a cellular network interface, or the like.

Device 200 may perform one or more processes described herein. Device 200 may perform these processes in response to processor 220 executing software instructions stored by a non-transitory computer-readable medium, such as memory 230 and/or storage component 240. A computer-readable medium is defined herein as a non-transitory memory device. A memory device includes memory space within a single physical storage device or memory space spread across multiple physical storage devices.

Software instructions may be read into memory 230 and/or storage component 240 from another computer-readable medium or from another device via communication interface 270. When executed, software instructions stored in memory 230 and/or storage component 240 may cause processor 220 to perform one or more processes described herein.

Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 2 are provided as an example. In practice, device 200 may include additional components, fewer components, different components, or differently arranged components than those shown in FIG. 2. Additionally, or alternatively, a set of components (e.g., one or more components) of device 200 may perform one or more functions described as being performed by another set of components of device 200.

Provided is a system and method that include mapping permissions with modules and sub-modules. As referred to herein, a module may refer an application or collection of applications (e.g., administration applications, core applications, fault management applications, etc.) where each application includes at least one parent application and at least one child application. The system and method may map permissions to a role, and the role may be assigned to a user, thus allowing for dynamic permission changing while not requiring redeployment (i.e., not requiring restarting or recompiling) of the system to implement the permission changes. Furthermore, the module permissions may be managed from a graphical user interface (GUI) of the system itself, and the changes to permissions may be made without relaunching the GUI.

Thus, the provided system allows for updating static configurations of the modules, where permissions may be added to the module, an icon of the module to be displayed may be changed (i.e., on the GUI, the system may only display the parent and child applications to which a user has permissions), and the visualization hierarchy of the module may be updated without any redeployment of the system. Further, the permissions change process is simplified, the time of deployment is reduced, the chances of issues after deployment are reduced, and the application development speed is increased.

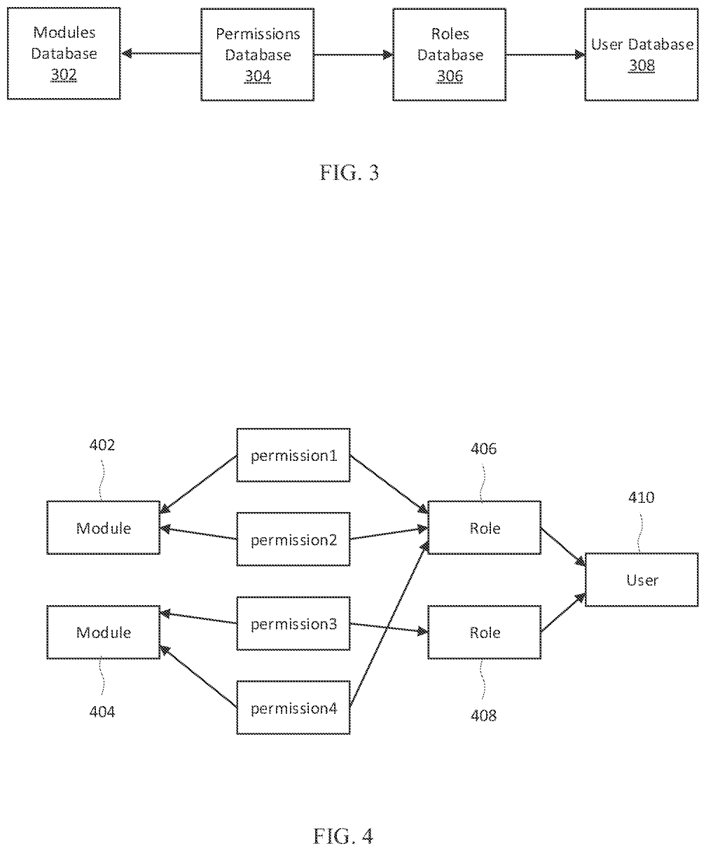

FIG. 3 is a diagram of a module management system, according to an embodiment. The module management system may include a modules database 302, a permissions database 304, a roles database 306, and a user database 308. The roles database 306 may be managed by a roles management module, and the user database 308 may be managed by a user management module. The modules database 302 may be configured to store a list of modules available on the system, along with a list of corresponding parent and child applications. The permissions database 304 may be configured to store a list of permissions (e.g., “read,” “access,” etc. to particular parent and/or child applications) corresponding to modules, the list of which is stored in the module database 302. The roles database 306 may be configured to store a list of roles that may be generated based on permissions accessed from the permissions database 304. A role may be an identified status for a user that includes a number of permissions. For example, a role may include a permission to “read” a child application of a first parent application, and a permission to “access” a child application of a second application. That is, the roles may not be limited to only one module. The user database 308 may be configured to store a role that has been assigned to any number of users. In other words, a user may have at least one role assigned to them and the assigned role may be stored in the user database 308. Each role may include at least one permission, and the role may be stored in the roles database 306. Each permission may be associated with at least one module, and the permission may be stored in the permission database 304. In some embodiments, each permission may be associated with only one module.

FIG. 4 is a diagram of an example permission assignment, according to an embodiment. FIG. 4 shows a first module 402, a second module 404, a first role 406, a second role 408 and a user 410. For the first role 406 may include permission1 and permission2 for the first module 402, as well as permission4 of the second module 404. The second role 408 may include only permission3 for the second module 404. One, both or neither role may be assigned to the user 410. The role of the user 410 may be dynamically changed during operation of the system, and the various roles may also be generated or modified during operation of the system, such that new permissions may be granted dynamically without requiring redeployment of the system.

The permissions may include action based permissions. For example, the permission may be a one-time use permission (e.g., one download per report) or a limited multiple use permission for various accesses to the corresponding modules. In one example, there may be ten different permissions corresponding to ten different actions possible in an application, and thus, each of the permissions may be associated with a single module.

In some embodiments, a user may have multiple roles, such as one role for each module, or a combined role to access multiple modules. The system may create a global access role (i.e., full access to all modules) or an application specific role. The system may receive a request from a user regarding a module to access, where the module includes at least one parent application and the parent application may include at least one child application. In some embodiments, the parent application may include no child applications. As referred to herein, the terms “modules” and “applications” may be interchanged. The modules may include predefined roles including predefined permissions.

For updating, the system may utilize an access database application programming interface (API) (i.e., a backend API), such that it is not required for the system to deploy the GUI. The system updates (i.e., updates roles in response to a user request) may be automatically reflected in the mapping of the roles and permissions. That is, the changes, such as adding a module, programming a permission, etc., may be handled in the backend (i.e., accessing and editing a database including the changed information) such that the UI on the front end automatically updates to reflect the changes without having to redeploy the system.

On a GUI of the system, the system may be configured to display, for a user, only those applications to which the user has a permission. For example, the GUI may display the parent application of the child application to which the user has a permission, and then display the child applications to which the user has a permission. Therefore, the user may visually identify to which child applications the user has an access based on permissions.

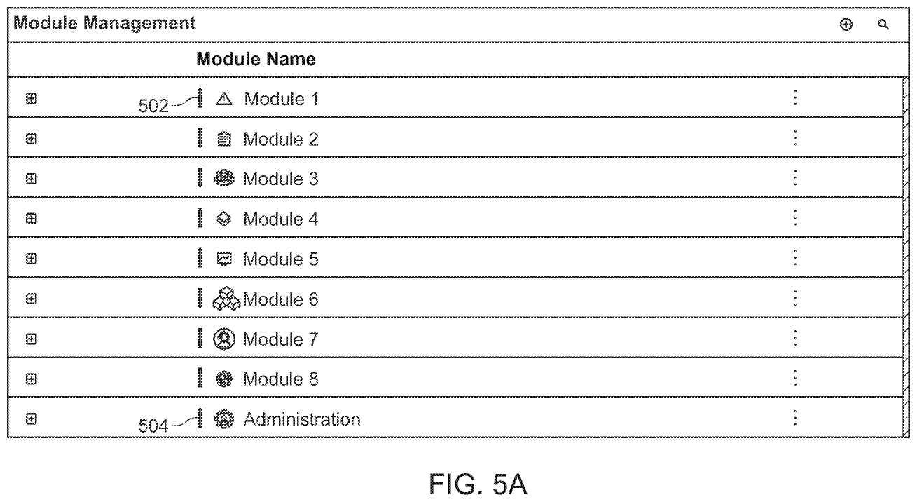

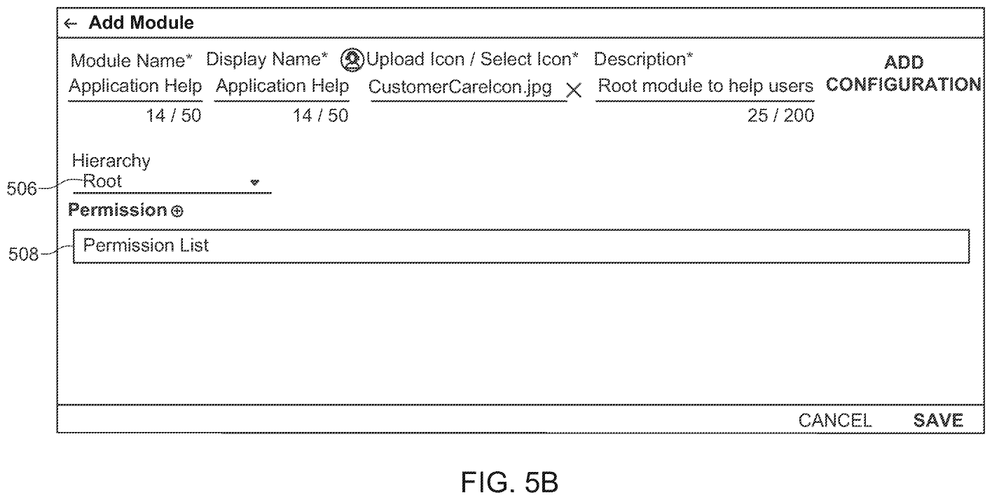

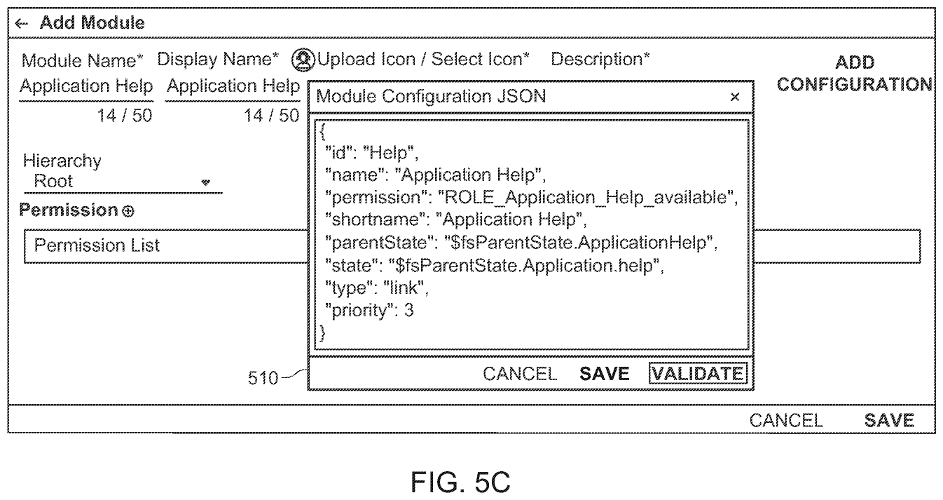

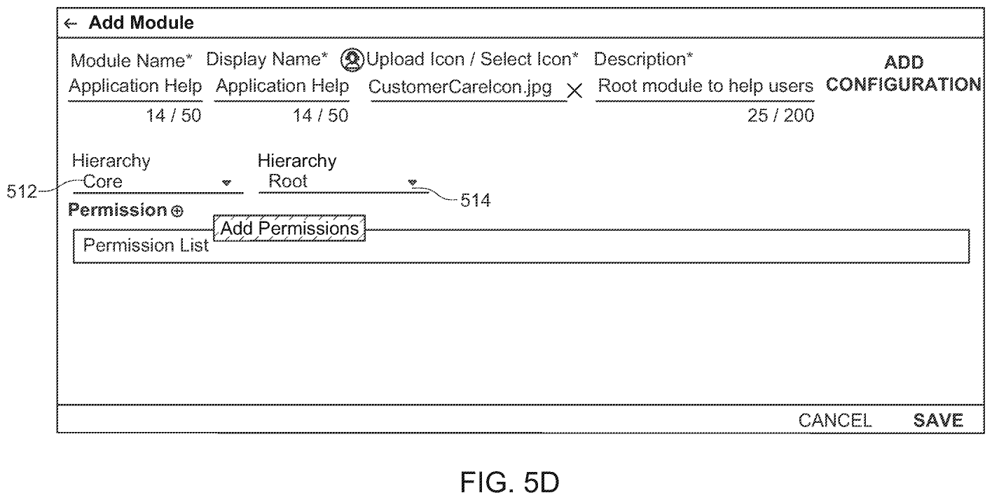

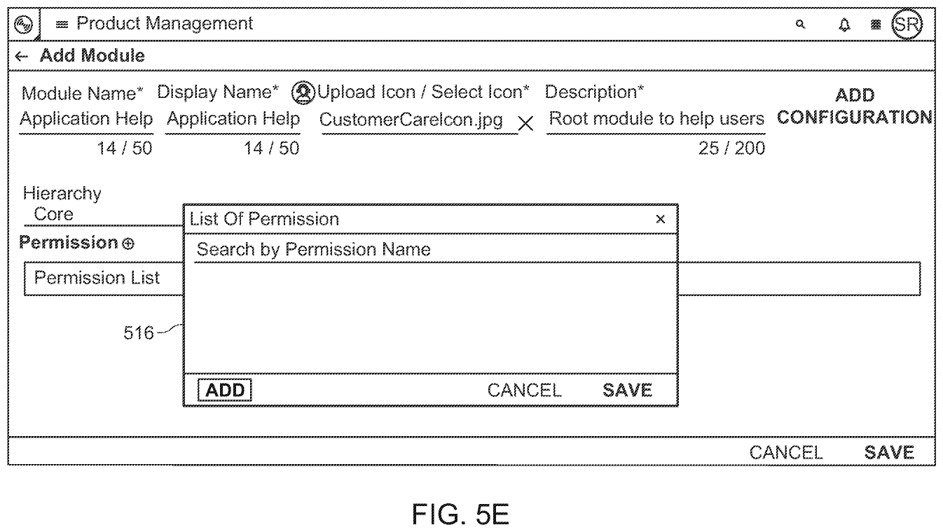

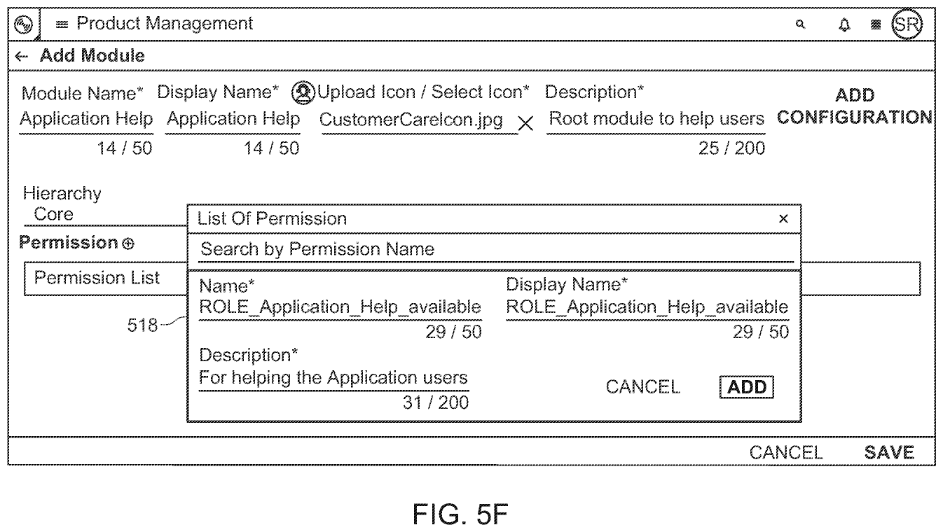

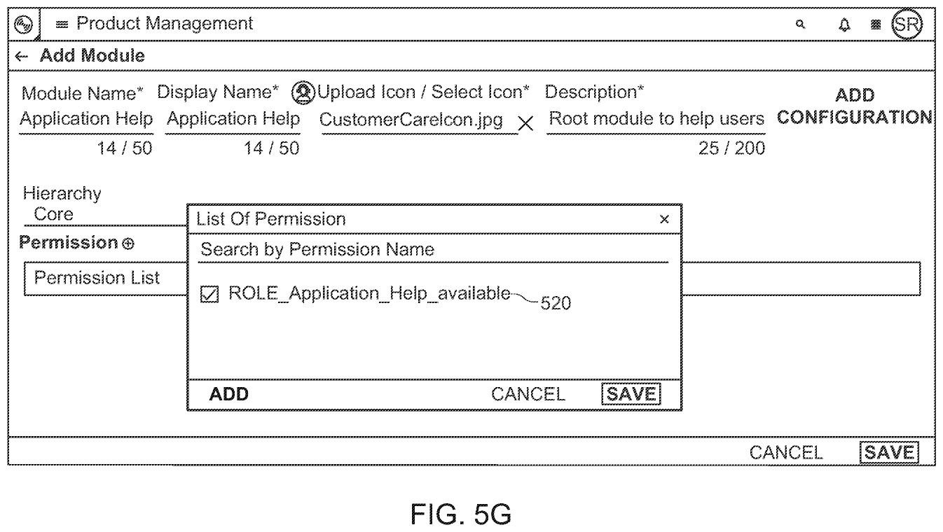

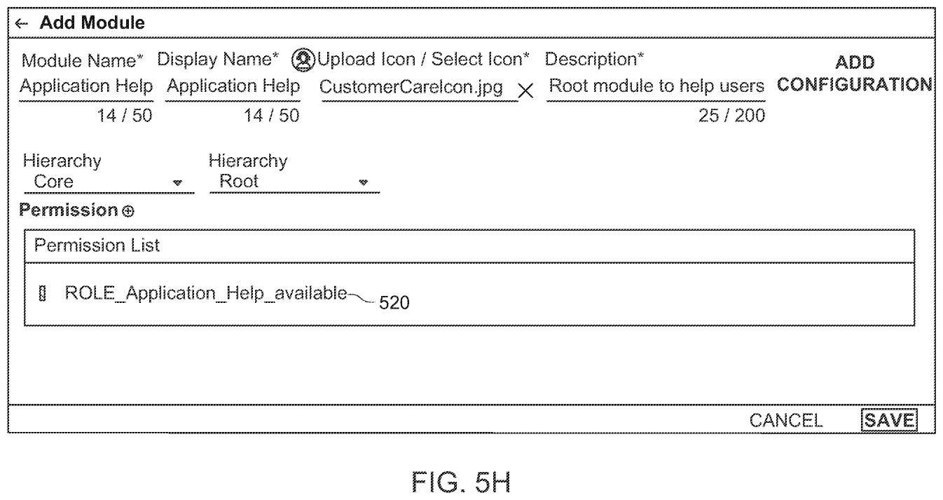

FIGS. 5A-5H are diagrams showing a configuration of a module, according to an embodiment. Referring to FIG. 5A, a module management interface may display a list of modules, such as module 502 and an administration module 504. As shown in FIG. 5B, a user may add a module, and include information such as the module name, the display name, description, hierarchy 506 and permissions 508. Referring to FIG. 5C, a user may add a configuration to the module, and the system may display a configuration window 510. The module may be configured based on Javascript Object Notation (JSON). As shown in FIG. 5D, the module may have a first hierarchy 512 and a second hierarchy 514.

Referring to FIG. 5E, a permission list window 516 may be displayed for adding permissions corresponding to the module. As shown in FIG. 5F, the system may display a name of the permission, a display name of the permission, as well as a description of the permission. When the permission is added, as shown in FIG. 5G, the permission 520 is displayed and a checkbox may be utilized to initiate the permission 520 or deactivate the permission 520. When completed, as shown in FIG. 5H, the permission 520 is added to the permission list for the module.

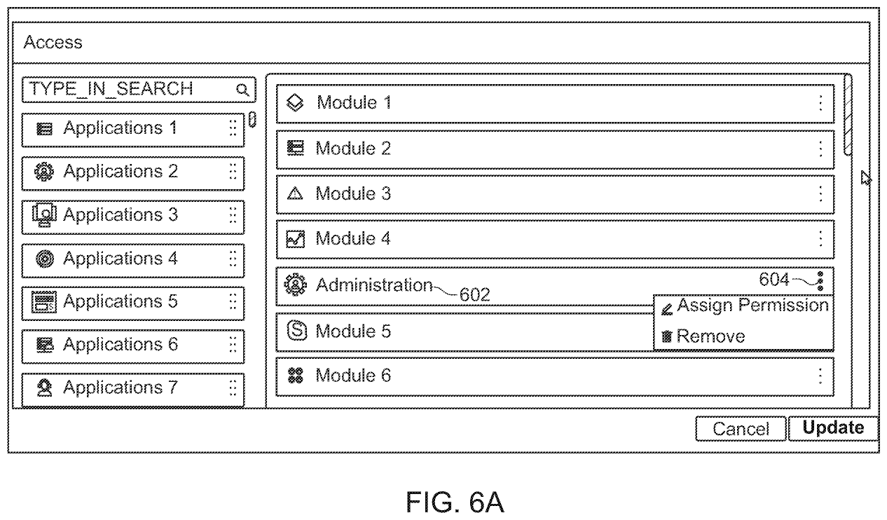

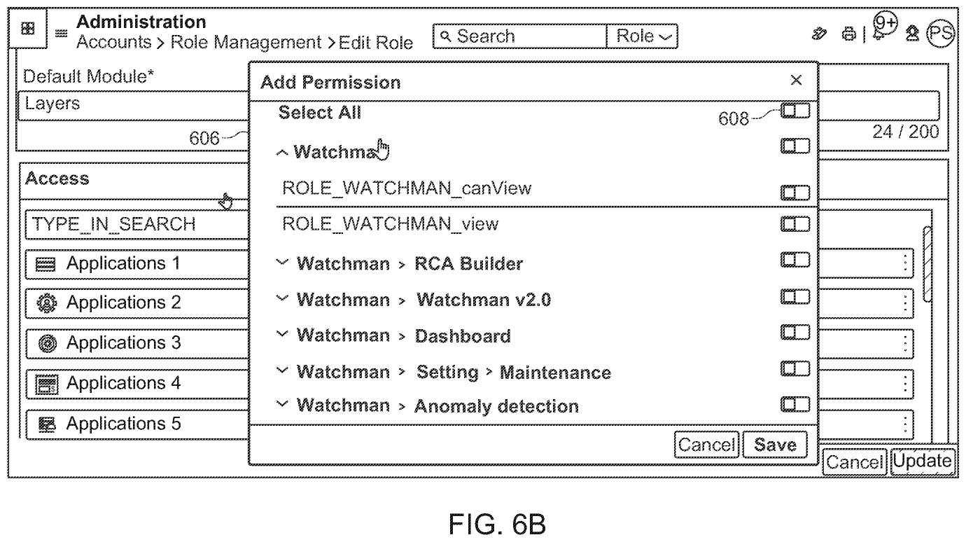

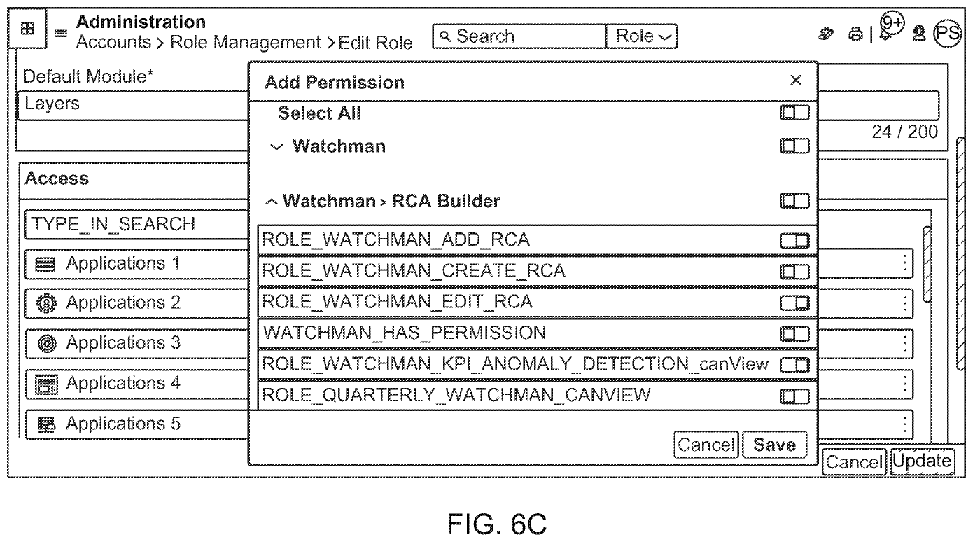

FIGS. 6A-6C are diagrams showing dynamic application of permissions, according to an embodiment. Referring to FIG. 6A, the system may display applications, such as the administration application 602. A user may select the application at 604 and assign a permission while the module management system is operating. As shown in FIG. 6B, the system may display an add permission window 606, where slide boxes 608 may be utilized to activate or deactivate permission during operation of the module management system. As shown in FIG. 6C, various roles and permissions may be activated or deactivated in real-time.

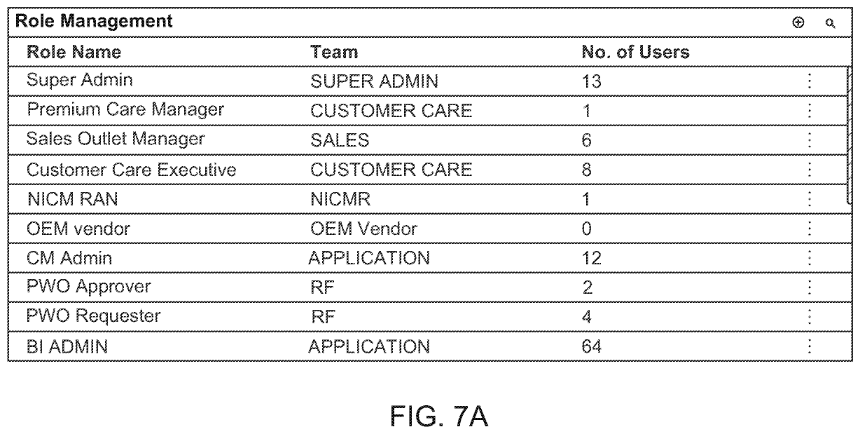

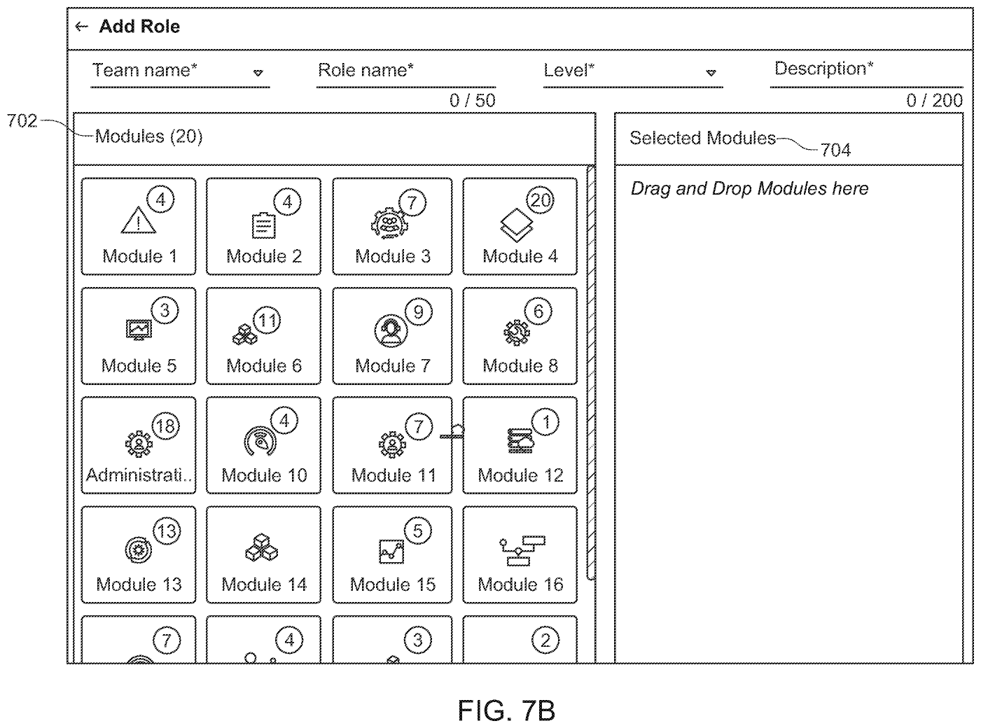

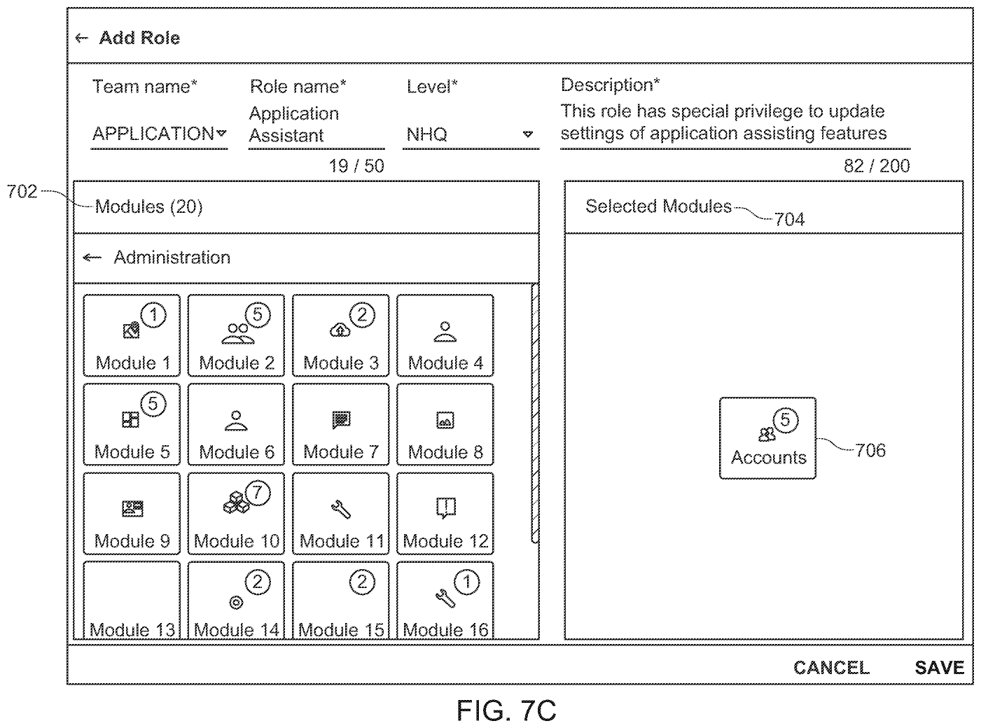

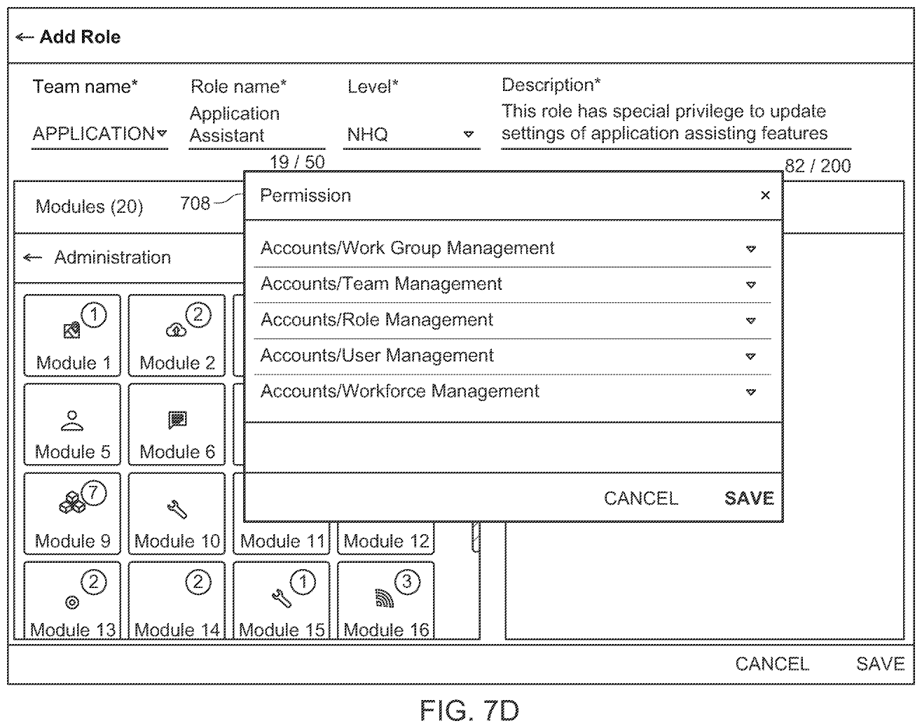

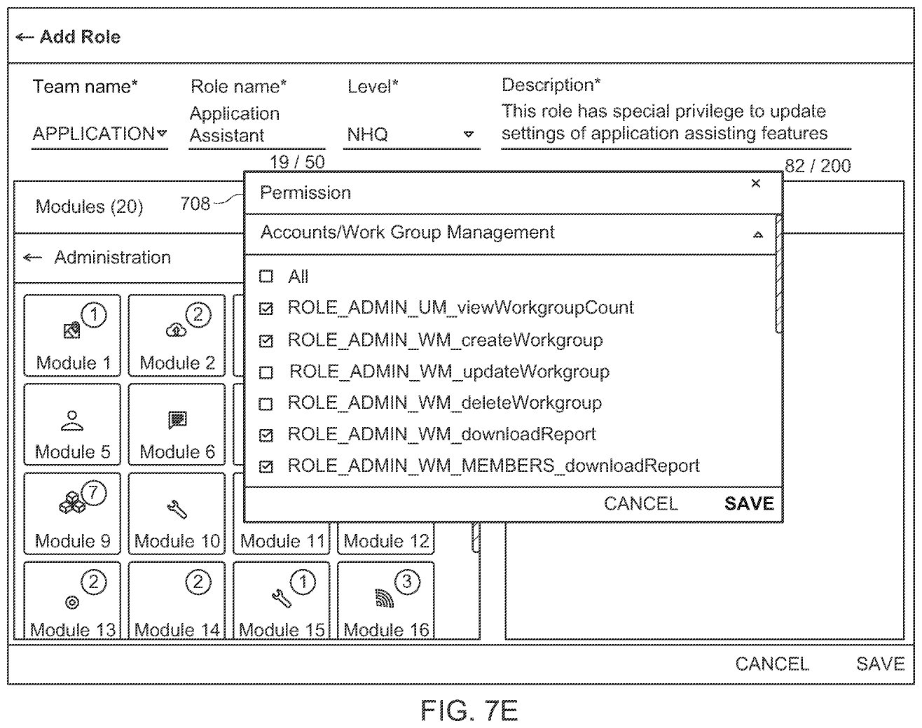

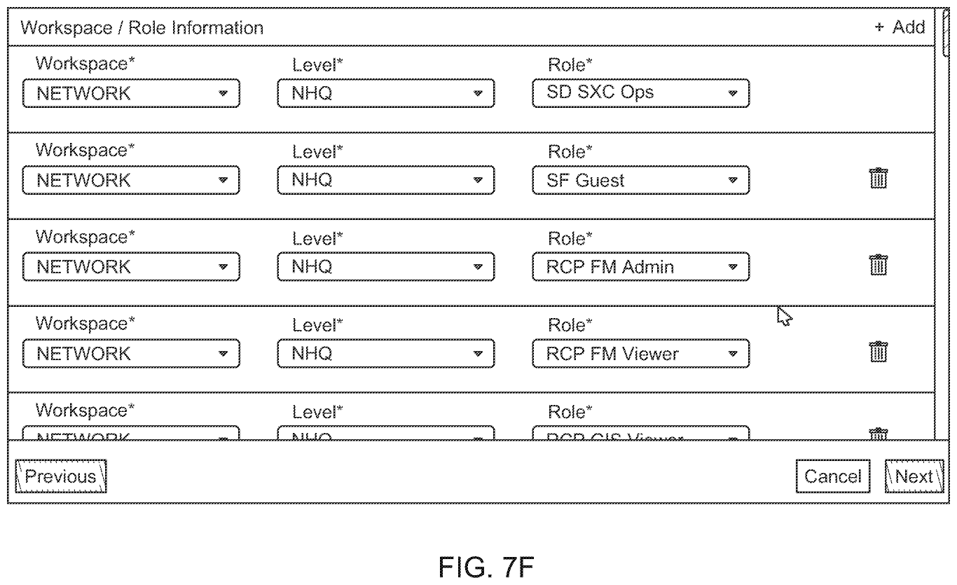

FIGS. 7A-7F are diagrams showing role assignment, according to an embodiment. Referring to FIG. 7A, the module management system may provide a role management window showing role names, teams belonging to the roles, number of users assigned to the roles, etc. As shown in FIG. 7B, when a user wants to add a role to the system, the system may provide a modules section 702 and a selected modules area 704. A user may select a module from the modules section 702, and drag the module to the selected module area 704. As shown in FIG. 7C, the “accounts” module 706 is selected. Referring to FIG. 7D, the system may provide a permissions window 708, which, as shown in FIG. 7E, provides a list of active roles (roles with checkmarks) and inactive roles (roles without checkmarks and roles that are available, such that further configuration or redeployment of the module management system is not required to change into the unchecked roles). As shown in FIG. 7F, the system may provide role information, such as the corresponding workspace, level, and role name.

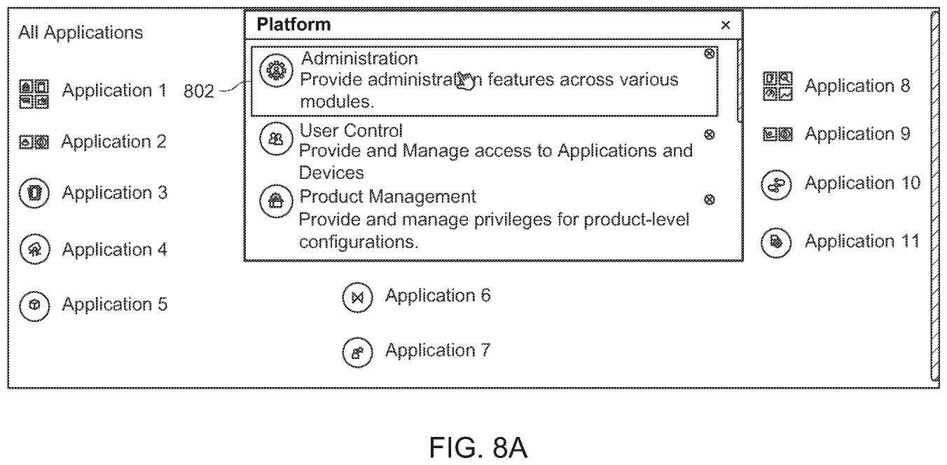

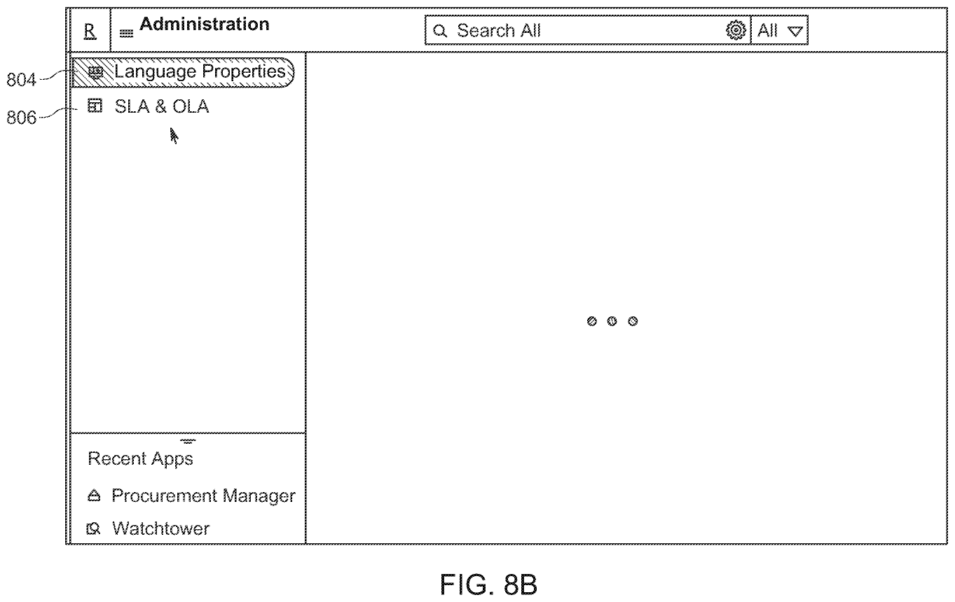

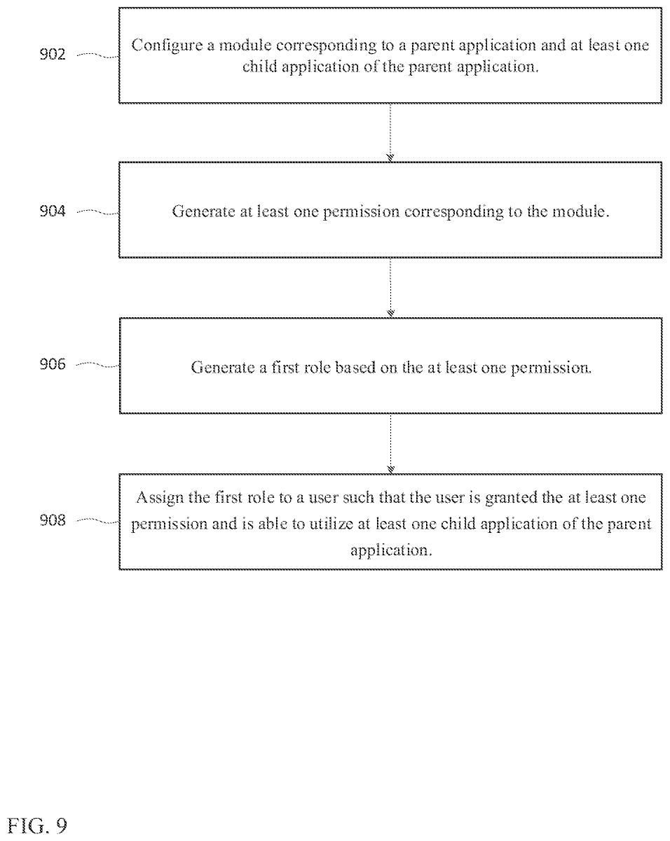

FIGS. 8A and 8B are diagrams showing displays of parent applications and child applications, according to an embodiment. As shown in FIG. 8A, a list of parent applications, such as the administration application 802 may be displayed. As shown in FIG. 8B, when the administration application 802 is selected, the system may display child applications 804 and 806. In one embodiment, the child applications 804 and 806 correspond to the number of child applications to which the user has permission to access (i.e., other child applications corresponding to the administration application 802 to which the user does not have permission to access are not displayed).

FIG. 9 is a flowchart of a method of a module management system, according to an embodiment. In operation 902, the system may configure a module corresponding to a parent application. The system may configure a module that corresponds to a parent application which includes at least one child application. In operation 904, the system may generate at least one permission corresponding to the module. The at least one permission may include a first permission corresponding to a first access to the module and a second permission corresponding to a second access to the module. In operation 906, the system may generate a first role based on the at least one permission. The first role may be generated based on the first permission. The system may generate a second role based on the second permission. In operation 908, the system may assign the first role to a user such that the user is granted the at least one permission and is able to utilize the parent application. In embodiments where the parent application includes at least one child application, the at least one child application may include a first plurality of child applications to which the at least one permission grants an access and a second plurality of child application to which the at least one permission does not grant an access. Furthermore, the system may display, on a GUI, only the first plurality of child applications.

In embodiments, any one of the operations or processes of FIGS. 3-9 may be implemented by or using any one of the elements illustrated in FIGS. 1 and 2.

The foregoing disclosure provides illustration and description, but is not intended to be exhaustive or to limit the implementations to the precise form disclosed. Modifications and variations are possible in light of the above disclosure or may be acquired from practice of the implementations.

Some embodiments may relate to a system, a method, and/or a computer readable medium at any possible technical detail level of integration. Further, one or more of the above components described above may be implemented as instructions stored on a computer readable medium and executable by at least one processor (and/or may include at least one processor). The computer readable medium may include a computer-readable non-transitory storage medium (or media) having computer readable program instructions thereon for causing a processor to carry out operations.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer readable media according to various embodiments. In this regard, each block in the flowchart or block diagrams may represent a module, segment, or portion of instructions, which comprises one or more executable instructions for implementing the specified logical function(s). The method, computer system, and computer readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

What is claimed is:

1. A method of a module management system, comprising:
configuring a module corresponding to a parent application;
generating at least one permission corresponding to the module;
generating a first role based on the at least one permission; and
assigning the first role to a user such that the user is granted the at least one permission and is able to utilize the parent application.

2. The method of claim 1, wherein the at least one permission comprises a first permission corresponding to a first access to the module and a second permission corresponding to a second access to the module.

3. The method of claim 2, wherein the first role is generated based on the first permission, and
wherein the method further comprises generating a second role based on the second permission.

4. The method of claim 3, further comprising, during operation of the module management system, changing a role of the user from the first role to the second role such that a permission of the user is changed from the first permission to the second permission without requiring redeployment of the module management system.

5. The method of claim 4, further comprising, in response to the changing of the role, updating a graphical user interface (GUI) to display applications to which the user has access based on the second permission.

6. The method of claim 1, wherein the parent application comprises at least one child application, and
wherein the at least one child application comprises a first plurality of child applications to which the at least one permission grants an access and a second plurality of child application to which the at least one permission does not grant an access.

7. The method of claim 6, further comprising displaying, on a graphical user interface (GUI), only the first plurality of child applications.

8. A module management system, comprising:
a memory storing instructions; and
a processor configured to execute the instructions to:
configure a module corresponding to a parent application;
generate at least one permission corresponding to the module;
generate a first role based on the at least one permission; and
assign the first role to a user such that the user is granted the at least one permission and is able to utilize the parent application.

9. The module management system of claim 8, wherein the at least one permission comprises a first permission corresponding to a first access to the module and a second permission corresponding to a second access to the module.

10. The module management system of claim 9, wherein the first role is generated based on the first permission, and
wherein the processor is further configured to execute the instructions to generate a second role based on the second permission.

11. The module management system of claim 10, wherein, during operation of the module management system, the processor is further configured to execute the instructions to change a role of the user from the first role to the second role such that a permission of the user is changed from the first permission to the second permission without requiring redeployment of the module management system.

12. The module management system of claim 11, wherein, in response to the changing of the role, the processor is further configured to execute the instructions to update a graphical user interface (GUI) to display applications to which the user has access based on the second permission.

13. The module management system of claim 8, wherein the parent application comprises at least one child application, and
wherein the at least one child application comprises a first plurality of child applications to which the at least one permission grants an access and a second plurality of child application to which the at least one permission does not grant an access.

14. The module management system of claim 13, wherein the processor is further configured to execute the instructions to display, on a graphical user interface (GUI), only the first plurality of child applications.

15. A non-transitory computer-readable storage medium of a module management system, the storage medium storing instructions that, when executed by at least one processor, cause the at least one processor to:
configure a module corresponding to a parent application;
generate at least one permission corresponding to the module;
generate a first role based on the at least one permission; and
assign the first role to a user such that the user is granted the at least one permission and is able to utilize the parent application.

16. The storage medium of claim 15, wherein the at least one permission comprises a first permission corresponding to a first access to the module and a second permission corresponding to a second access to the module.

17. The storage medium of claim 16, wherein the first role is generated based on the first permission, and
wherein the instructions, when executed, further cause the at least one processor to generate a second role based on the second permission.

18. The storage medium of claim 17, wherein, during operation of the module management system, the instructions, when executed, further cause the at least one processor to change a role of the user from the first role to the second role such that a permission of the user is changed from the first permission to the second permission without requiring redeployment of the module management system.

19. The storage medium of claim 18, wherein, in response to the changing of the role, the instructions, when executed, further cause the at least one processor to update a graphical user interface (GUI) to display applications to which the user has access based on the second permission.

20. The storage medium of claim 15, wherein the parent application comprises at least one child application,
wherein the at least one child application comprises a first plurality of child applications to which the at least one permission grants an access and a second plurality of child application to which the at least one permission does not grant an access, and
wherein the instructions, when executed, further cause the at least one processor to display, on a graphical user interface (GUI), only the first plurality of child applications.
